(19) United States
(12) Patent Application Publication
(10) Pub. No.: US 2022/0393629 A1
(43) Pub. Date: Dec. 8, 2022

(54) CONTROL DEVICE FOR ELECTRIC MOTOR

(71) Applicant: KABUSHIKI KAISHA TOYOTA JIDOSHOKKI, Kariya-shi, Aichi (JP)

(72) Inventors: Kazuki ASAHINA, Aichi-ken, Japan (JP); Daisuke MATSUOKA, Aichi-ken (JP); Masamichi NAWA, Aichi-ken (JP)

(73) Assignee: KABUSHIKI KAISHA TOYOTA JIDOSHOKKI, Kariya-shi, Aichi (JP)

(21) Appl. No.: 17/779,277

(22) PCT Filed: Oct. 26, 2020
(86) PCT No.: PCT/JP2020/040154

§ 371 Date: May 24, 2022

(30) Foreign Application Priority Data
Nov. 28, 2019 (JP) 2019-215716
Jul. 8, 2020 (JP) 2020-117519

(51) Int. Cl. H02P 21/26

(52) U.S. Cl. CPC H02P 21/26; H02P 27/08

(57) ABSTRACT

A control device for an electric motor includes: an inverter circuit configured to drive a rotor of the electric motor by a result of a comparison between a carrier wave and a voltage command value; and a control circuit configured to determine the voltage command value in every control period by vector control by using a current flowing through the electric motor, and a rotational speed and a position of the rotor. The control circuit is configured to shorten the control period as the rotational speed of the rotor or a modulation factor corresponding to the rotational speed of the rotor increases.

### TECHNICAL FIELD

The present invention relates to a control device for an electric motor.

### BACKGROUND ART

Some known control devices for an electric motor use the position of the rotor of the electric motor to covert three-phase alternating current flowing through the electric motor to a d-axis current and a q-axis current, determine a voltage command value such that the d-axis current and the q-axis current approach a current command value, and control the drive of the electric motor by a drive signal corresponding to a result of a comparison between the voltage command value and a carrier wave, in other words, some known control devices perform drive control of the electric motor by vector control. Related art includes Patent Literature 1.

### CITATION LIST

### Patent Literature

[Patent Literature 1] Japanese Patent Application Publication No. 2001-169590

### SUMMARY OF INVENTION

### Technical Problem

However, in the aforementioned control devices, if the rotational speed (rotational frequency) of the rotor or the modulation factor corresponding to the rotational speed of the rotor becomes relatively large, the duty cycle of the drive signal may not be varied according to the amplitude value of the voltage command value, so that drive controllability of the electric motor may deteriorate.

An object according to one aspect of the present invention is, in a control device for performing drive control of an electric motor by vector control, to suppress deterioration of drive controllability of the electric motor even if a rotational speed of a rotor of the electric motor or a modulation factor is relatively large.

### Solution to Problem

A control device for an electric motor according to one embodiment of the present invention comprises: an inverter circuit configured to drive a rotor of the electric motor by a result of a comparison between a voltage command value and a carrier wave; and a control circuit configured to determine a voltage command value in every control period by vector control by using a current flowing through the electric motor and a rotational speed and a position of the rotor.

The control circuit is configured to shorten the control period as the rotational speed of the rotor or a modulation factor corresponding to the rotational speed of the rotor increases.

This reduces the possibility that the duty cycle of the drive signal may not be varied according to the amplitude value of the voltage command value even if the rotational speed of the rotor of the electric motor or the modulation factor becomes relatively large, thereby suppressing deterioration of controllability of the electric motor.

The control circuit may be configured to estimate the rotational speed and the position of the rotor in every control period by using a current flowing through the electric motor.

Furthermore, a control device for an electric motor according to one embodiment of the present invention comprises: an inverter circuit configured to drive a rotor of the electric motor by a result of a comparison between a voltage command value and a carrier wave; and a control circuit configured to determine a voltage command value by vector control by using a current flowing through the electric motor and a rotational speed and a position of the rotor.

The control circuit may be configured to shorten the control period as the rotational speed or the modulation factor increases, of all processes of the control circuit, in an acquisition process for acquiring the current flowing through the electric motor and in an estimate process for estimating the position by using the acquired current, whereas the control circuit may be configured to keep the control period constant in the processes of the control circuit other than the acquisition process and the estimate process.

This configuration allows an increase in the number of samplings of the current flowing through the electric motor as the rotational speed or the modulation factor increases, thereby allowing an increase in the estimate accuracy of the position. This configuration therefore allows calculation of the voltage command value by using the position, thereby suppressing deterioration of controllability of the electric motor. This configuration further allows the control device to shorten the control period in some of all processes of the control circuit, while keeping the control period constant in other processes, thereby reducing the processing load on the control circuit.

### Advantageous Effects of Invention

According to the present invention, in a control device for performing drive control of an electric motor by vector control, deterioration of drive controllability of the electric motor may be suppressed even if a rotational speed of a rotor of the electric motor or a modulation factor is relatively large.

### BRIEF DESCRIPTION OF THE DRAWINGS

FIG. 1 is a diagram illustrating an example of a control device for an electric motor according to a first embodiment.

FIG. 2 is a diagram illustrating another example of the control device for the electric motor according to the first embodiment.

FIG. 3 is a diagram illustrating an example of a carrier wave, a voltage command value, and a drive signal.

### DESCRIPTION OF EMBODIMENTS

### First Embodiment

Hereinafter, embodiments will be described in detail with reference to the drawings.

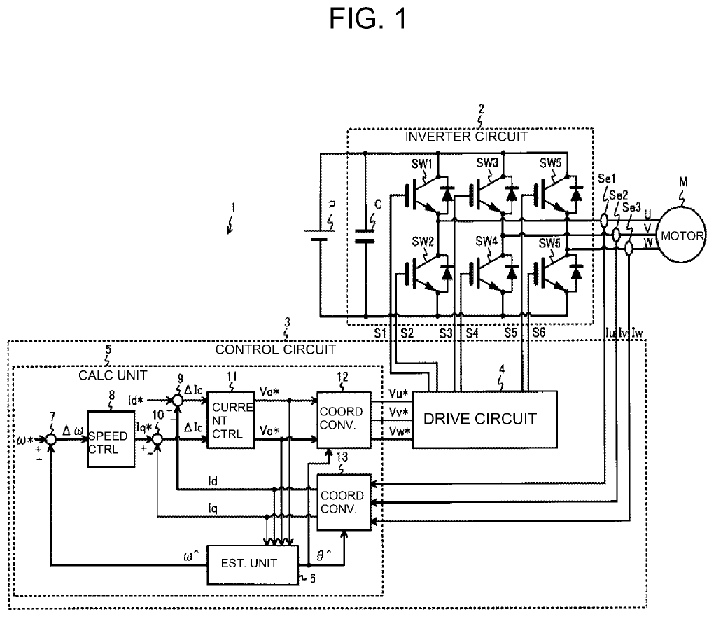

FIG. 1 is a diagram illustrating an example of a control device for an electric motor according to a first embodiment.

A control device 1 illustrated in FIG. 1 is, for example, a control device for performing drive control of an electric motor M mounted on a vehicle, such as an electric forklift truck or a plug-in hybrid vehicle, and includes an inverter circuit 2, a control circuit 3, and current sensors Se1 to Se3.

The inverter circuit 2 drives the electric motor M with direct-current power supplied from a direct-current power supply P, and includes a capacitor C and switching elements SW1 to SW6 (e.g., an Insulated Gate Bipolar Transistor (IGBT)). More specifically, one end of the capacitor C is connected to a positive terminal of the direct-current power supply P and respective collector terminals of the switching elements SW1, SW3, and SW5, and the other end of the capacitor C is connected to a negative terminal of the direct-current power supply P and respective emitter terminals of the switching elements SW2, SW4, and SW6. The connection point between an emitter terminal of the switching element SW1 and a collector terminal of the switching element SW2 is connected to a U-phase input terminal of the electric motor M via the current sensor Se1. The connection point between an emitter terminal of the switching element SW3 and a collector terminal of the switching element SW4 is connected to a V-phase input terminal of the electric motor M via the current sensor Se2. The connection point between an emitter terminal of the switching element SW5 and a collector terminal of the switching element SW6 is connected to a W-phase input terminal of the electric motor M via the current sensor Se3.

The capacitor C smooths voltage that is output from the direct-current power supply P and input to the inverter circuit 2.

The switching element SW1 is turned on or off by a drive signal S1 output from the control circuit 3. The switching element SW2 is turned on or off by a drive signal S2 output from the control circuit 3. The switching element SW3 is turned on or off by a drive signal S3 output from the control circuit 3. The switching element SW4 is turned on or off by a drive signal S4 output from the control circuit 3. The switching element SW5 is turned on or off by a drive signal S5 output from the control circuit 3. The switching element SW6 is turned on or off by a drive signal S6 output from the control circuit 3. The direct current output from the direct-current power supply P is converted to three alternating current powers that differ in phase from each other by 120 degrees when the switching elements SW1 to SW6 are each turned on or off, and the alternating current powers are input to the U-phase input terminal, the V-phase input terminal, and the W-phase input terminal of the electric motor M so as to rotate a rotor of the electric motor M.

Each of the current sensors Se1 to Se3 includes a Hall element, a shunt resistor, and the like. The current sensors Se1 to Se3 respectively detect currents Iu, Iv, Iw flowing through the U-phase, V-phase, and W-phase of the electric motor M, and output them to the control circuit 3.

The control circuit 3 includes a drive circuit 4 and a calculation unit 5.

The drive circuit 4 includes an integrated circuit (IC) and the like, and the drive circuit 4 compares, in every control period, voltage command values Vu*, Vv*, Vw* output from the calculation unit 5 with a carrier wave (triangle wave, sawtooth wave, reverse sawtooth wave, or the like) and outputs the drive signals S1 to S6, which correspond to the comparison results, to the gate terminals of the switching elements SW1 to SW6. For example, the drive circuit 4 outputs the high-level drive signal S1 and the low-level drive signal S2 when the voltage command value Vu* is equal to or greater than the carrier wave, whereas the drive circuit 4 outputs the low-level drive signal S1 and the high-level drive signal S2 when the voltage command value Vu* is smaller than the carrier wave. The drive circuit 4 outputs the high-level drive signal S3 and the low-level drive signal S4 when the voltage command value Vv* is equal to or greater than the carrier wave, whereas the drive circuit 4 outputs the low-level drive signal S3 and the high-level drive signal S4 when the voltage command value Vv* is smaller than the carrier wave. The drive circuit 4 outputs the high-level drive signal S5 and the low-level drive signal S6 when the voltage command value Vw* is equal to or greater than the carrier wave, whereas the drive circuit 4 outputs the low-level drive signal S5 and the high-level drive signal S6 when the voltage command value Vw* is smaller than the carrier wave.

The drive circuit 4 performs Pulse Width Modulation (PWM) control when amplitude values of the voltage command values Vu*, Vv*, Vw* are smaller than an amplitude value of the carrier wave so that the switching elements SW1 to SW6 are repeatedly turned on/off in one period of the voltage command values Vu*, Vv*, Vw*.

The drive circuit 4 also performs on-off control (overmodulation control) when the amplitude values of the voltage command values Vu*, Vv*, Vw* are greater than the amplitude value of the carrier wave so that the switching elements SW1 to SW6 are repeatedly turned on/off in a part of one period of the voltage command values Vu*, Vv*, Vw* and are always on or off in the rest of one period of the voltage command values Vu*, Vv*, Vw*.

Furthermore, the drive circuit 4 performs on-off control (square wave control) when the amplitude values of the voltage command values Vu*, Vv*, Vw* are even greater than the amplitude value of the carrier wave so that the switching elements SW1 to SW6 are always on or off in a half period of the voltage command values Vu*, Vv*, Vw* and in the other half period of the voltage command values Vu*, Vv*, Vw*.

When it is not necessary to distinguish the voltage command values Vu*, Vv*, Vw*, the voltage command value is referred to as the voltage command value V*. When it is not necessary to distinguish the drive signals S1 to S6, the drive signal is referred to as the drive signal S.

The calculation unit 5 includes a microcomputer and the like, and includes an estimation unit 6, a subtraction unit 7, a speed control unit 8, subtraction units 9, 10, a current control unit 11, a coordinate conversion unit 12, and a coordinate conversion unit 13. For example, the microcomputer executes a program stored in a storage unit, which is not illustrated, to activate the estimation unit 6, the subtraction unit 7, the speed control unit 8, the subtraction units 9, 10, the current control unit 11, the coordinate conversion unit 12, and the coordinate conversion unit 13.

The estimation unit 6 estimates the rotational speed (rotational frequency) ω\hat{ } and the position θ\hat{ } of the rotor of the electric motor M in every control period by using a d-axis voltage command value Vd* and a q-axis voltage command value Vq* output from the current control unit 11 and a d-axis current Id and a q-axis current Iq output from the coordinate conversion unit 13.

For example, the estimation unit 6 calculates a counter-electromotive force ed\hat{ } and a counter-electromotive force eq\hat{ } by using the following formula 1 and formula 2, respectively. In the formulas, the resistance of the electric motor M is expressed by R, and the inductance of a coil of the electric motor M is expressed by L.

ed\hat{ }=Vd*−R×Id+ω\hat{ }×L×Id formula 1

eq\hat{ }=Vq*−R×Iq−ω\hat{ }×L×Iq formula 2

The estimation unit 6 calculates an error θe\hat{ } by using the following formula 3.

θe\hat{ }=tan⁻¹(ed\hat{ }/eq\hat{ }) formula 3

The estimation unit 6 calculates the rotational speed ω\hat{ } by using the following formula 4 such that the error θe\hat{ } is 0. The proportional gain of Proportional Integral (PI) control is expressed by Kp, and the integral gain of PI control is expressed by Ki.

ω\hat{ }=Kp×θe\hat{ }+Ki×∫(θe\hat{ })dt formula 4

The estimation unit 6 calculates the position θ\hat{ } by using the following formula 5. The Laplace operator is expressed by s.

θ\hat{ }=(1/s)×ω\hat{ } formula 5

The subtraction unit 7 calculates a difference Δω between a rotational speed command value ω* externally input and the rotational speed ω\hat{ } output from the estimation unit 6 in every control period.

The speed control unit 8 converts the difference Δω output from the subtraction unit 7 to a q-axis current command value Iq* in every control period.

For example, the speed control unit 8 calculates the q-axis current command value Iq* by using the following formula 6 such that the difference Δω is 0.

Iq*=Kp×Δω+Ki×∫(Δω)dt formula 6

The subtraction unit 9 calculates the difference ΔId between a predetermined d-axis current command value Id* and the d-axis current Id output from the coordinate conversion unit 13 in every control period.

The subtraction unit 10 calculates the difference ΔIq between the q-axis current command value Iq* output from the speed control unit 8 and the q-axis current Iq output from the coordinate conversion unit 13 in every control period.

The current control unit 11 converts, in every control period, the difference ΔId output from the subtraction unit 9 and the difference ΔIq output from the subtraction unit 10 to the d-axis voltage command value Vd* and the q-axis voltage command value Vq*.

For example, the current control unit 11 calculates the d-axis voltage command value Vd* by using the following formula 7 and calculates the q-axis voltage command value Vq* by using the following formula 8. The q-axis inductance of the coil of the electric motor M is expressed by Lq, the d-axis inductance of the coil of the electric motor M is expressed by Ld, and the induced voltage is expressed by Ke.

Vd*=Kp×ΔId+Ki×∫(ΔId)dt−ωLqIq formula 7

Vq*=Kp×ΔIq+Ki×∫(ΔIq)dt+ωLdId+ωKe formula 8

For example, the coordinate conversion unit 12 converts the d-axis voltage command value Vd* and the q-axis voltage command value Vq* to the voltage command value Vv*, the voltage command value Vv*, and the voltage command value Vw* in every control period by using the position θ\hat{ } output from the estimation unit 6.

For example, the coordinate conversion unit 12 converts the d-axis voltage command value Vd* and the q-axis voltage command value Vq* to the voltage command value Vu*, the voltage command value Vv*, and the voltage command value Vw* by using the transformation matrix C1 expressed by the following formula 9.

$$\begin{matrix}[ Mathematical Formula 1 ] & \\ C 1 = \sqrt{\frac{2}{3}} [ \begin{matrix}cos θ \hat{} & - sin θ \hat{} \\ cos ( θ \hat{} - 2 π / 3 ) & - sin ( θ \hat{} - 2 π / 3 \\ cos ( θ \hat{} + 2 π / 3 ) & - sin ( θ \hat{} + 2 π / 3\end{matrix} ] & formula 9\end{matrix}$$

For example, the coordinate conversion unit 12 determines the phase angle δ by using the following formula 10.

δ=tan⁻¹(−Vq*/Vd*) formula 10

The coordinate conversion unit 12 then determines the target position θv by adding the phase angle δ to the position θ\hat{ }.

Next, the coordinate conversion unit 12 determines the modulation factor' by using the following formula 11. It is to be noted that 0<modulation factor'<1 is satisfied. The voltage of the direct-current power supply P is expressed by Vin.

$$\begin{matrix}[ Mathematical Formula 2 ] & \\ modulation {factor}^{′} = \frac{π \times \sqrt{{Vd}^{* 2} + {Vq}^{* 2}}}{\sqrt{6} \times {V}_{in}} & formula 11\end{matrix}$$

Next, the coordinate conversion unit 12 determines the modulation factor by using the following formula 12. It is to be noted that −1<modulation factor<1 is satisfied.

modulation factor=2×modulation factor'−1 formula 12

In addition, the coordinate conversion unit 12 refers to the information of the correspondence relationship between the target position θv and the voltage command values Vu*, Vv*, Vw*, which is previously stored in the storage unit (not illustrated), to determine the voltage command values Vu*, Vv*, Vw* corresponding to the target position θv.

For example, the coordinate conversion unit 13 converts the currents Iu, Iv, Iw respectively detected by the current sensors Se1 to Se3 to the d-axis current Id and the q-axis current Iq in every control period by using the position θ\hat{ } output from the estimation unit 6.

For example, the coordinate conversion unit 13 converts the currents Iu, Iv, Iw to the d-axis current Id and the q-axis current Iq by using the transformation matrix C2 expressed by the following formula 13.

$$\begin{matrix}[ Mathematical Formula 3 ] & \\ C 2 = \sqrt{\frac{2}{3}} [ \begin{matrix}cos θ \hat{} & cos ( θ \hat{} - 2 π / 3 ) & cos ( θ \hat{} + 2 π / 3 ) \\ - sin θ \hat{} & - sin ( θ \hat{} - 2 π / 3 & - sin ( θ \hat{} + 2 π / 3\end{matrix} ] & formula 13\end{matrix}$$

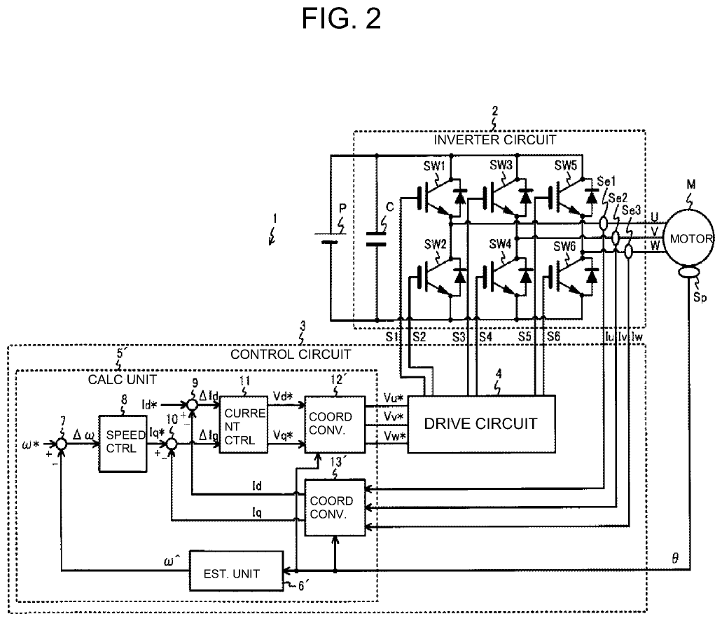

FIG. 2 is a diagram illustrating another example of the control device 1 for the electric motor M according to the first embodiment. It is to be noted that the same components as those illustrated in FIG. 1 are denoted by the same reference numerals and will not be elaborated.

In contrast to the control device 1 in FIG. 1, the control device 1 in FIG. 2 includes a position detection unit Sp (such as a resolver) that detects a position θ of the rotor of the electric motor M and transmits the detected position θ to the control circuit 3.

In contrast to the control device 1 in FIG. 1, the control device 1 in FIG. 2 includes a calculation unit 5′ instead of the calculation unit 5.

The calculation unit 5′ includes a microcomputer and the like, and includes an estimation unit 6′, the subtraction unit 7, the speed control unit 8, the subtraction units 9, 10, the current control unit 11, a coordinate conversion unit 12′, and a coordinate conversion unit 13′. For example, the microcomputer executes a program stored in a storage unit, which is not illustrated, to activate the estimation unit 6′, the subtraction unit 7, the speed control unit 8, the subtraction units 9, 10, the current control unit 11, the coordinate conversion unit 12′, and the coordinate conversion unit 13′.

The estimation unit 6′ estimates the rotational speed ω\hat{ } of the rotor of the electric motor M in every control period by using the position θ detected by the position detection unit Sp.

For example, the estimation unit 6′ estimates the rotational speed ω\hat{ } by dividing the position θ by the control period of the control circuit 3.

The coordinate conversion unit 12′ converts the d-axis voltage command value Vd* and the q-axis voltage command value Vq* to the voltage command value Vu*, the voltage command value Vu*, and the voltage command value Vw* in every control period by using the position θ detected by the position detection unit Sp.

For example, the coordinate conversion unit 12′ converts the d-axis voltage command value Vd* and the q-axis voltage command value Vq* to the voltage command value Vu*, the voltage command value Vv*, and the voltage command value Vw* by using the transformation matrix Cl expressed by the formula 9. It is to be noted that the position θ\hat{ } in the formula 9 should be replaced with the position θ.

For example, the coordinate conversion unit 12′ converts the d-axis voltage command value Vd* and the q-axis voltage command value Vq* to the voltage command value Vu*, the voltage command value Vv*, and the voltage command value Vw* by using the formulas 10 to 12 and the information previously stored in the storage unit (not illustrated). It is to be noted that the position θ\hat{ } should be replaced with the position θ to determine the target position θv.

The coordinate conversion unit 13′ converts the currents Iu, Iv, Iw respectively detected by the current sensors Se1 to Se3 to the d-axis current Id and the q-axis current Iq in every control period by using the position θ detected by the position detection unit Sp.

For example, the coordinate conversion unit 13 converts the currents Iu, Iv, Iw to the d-axis current Id and the q-axis current Iq by using the transformation matrix C2 expressed by the formula 13. It is to be noted that the position θ\hat{ } in the formula 13 should be replaced with the position θ.

The control circuit 3 in FIG. 1 and FIG. 2 sets the control period of the control circuit 3 to a control period T1 when the rotational speed ω\hat{ } is equal to or below the threshold ωth or when the modulation factor is equal to or below the threshold Mth, whereas the control circuit 3 sets the control period of the control circuit 3 to a control period T2, which is shorter than the control period T1, when the rotational speed ω\hat{ } is above the threshold ωth or when the modulation factor is above the threshold Mth. The threshold ωth is the maximum value of the rotational speed ω\hat{ } when the estimate accuracy of the rotational speed ω\hat{ } is not reduced. The threshold Mth is the maximum value of the modulation factor when the estimate accuracy of the rotational speed ω\hat{ } is not reduced.

The control circuit 3 in FIG. 1 and FIG. 2 may set the control period to the control period T1 in all processes of the control circuit 3 when the rotational speed ω\hat{ } is equal to or below the threshold ωth1 or when the modulation factor is equal to or below the threshold Mth1, whereas the control circuit 3 may set the control period to the control period T2 in all processes of the control circuit 3 when the rotational speed ω\hat{ } is above the threshold ωth1 or when the modulation factor is above the threshold Mth1. Furthermore, the control circuit 3 may set the control period to a control period T3 in all processes of the control circuit 3 when the rotational speed ω\hat{ } is equal to or above the threshold ωth2 or when the modulation factor is equal to or above the threshold Mth2. It is to be noted that threshold ωth1<threshold ωth2 is satisfied. Furthermore, threshold Mth1<threshold Mth2 is satisfied. In addition, control period T1>control period T2>control period T3 is satisfied. The threshold ωth1 is the maximum value of the rotational speed ω\hat{ } when the estimate accuracy of the rotational speed ω\hat{ } is not reduced. The threshold Mth1 is the maximum value of the modulation factor when the estimate accuracy of the rotational speed ω\hat{ } is not reduced. That is, the control circuit 3 in FIG. 1 and FIG. 2 may shorten the control period in all processes of the control circuit 3 as the rotational speed ω\hat{ } or the modulation factor increases.

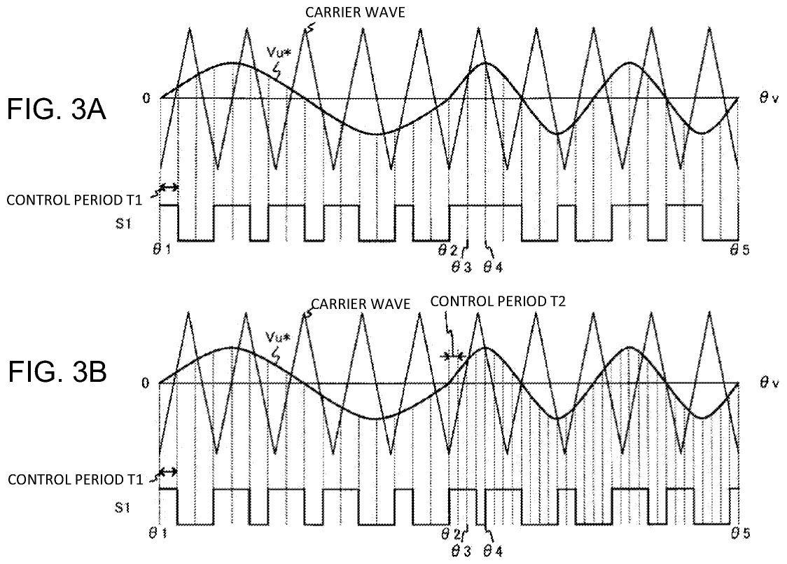

FIG. 3A and FIG. 3B are diagrams illustrating an example of the carrier wave, the voltage command value Vu*, and the drive signal S1. In FIG. 3A and FIG. 3B, the horizontal axis of the two-dimensional coordinates indicates the target position θv, and the vertical axis indicates the voltage. The frequency of the voltage command value Vu* during the time from the position θ2 to the position θ5 is higher than the frequency of the voltage command value Vu* during the time from the position θ1 to the position θ2. That is, the rotational speed ω\hat{ } during the time from the position θ1 to the position θ2 is equal to or below the threshold ωth, and the rotational speed ω\hat{ } during the time from the position θ2 to the position θ5 is above the threshold ωth. Alternatively, the modulation factor during the time from the position θ1 to the position θ2 is equal to or below the threshold Mth, and the modulation factor during the time from the position θ2 to the position θ5 is above the threshold Mth. In FIG. 3A, the control period T1 of the control circuit 3 is constant during the time from the position θ1 to the position θ5. In FIG. 3B, the control period

T2 of the control circuit 3 during the time from the position θ2 to the position θ5 is shorter than the control period T1 of the control circuit 3 during the time from the position θ1 to the position θ2. The amplitude values and frequencies of the carrier waves in FIG. 3A and FIG. 3B are constant during the time from the position θ1 to the position θ5.

The duty cycle of the drive signal S1 (the ratio of high-pulse duration of the drive signal S1 to one period of the carrier wave) is varied according to the amplitude value of the voltage command value Vu* during the time from the position θ1 to the position θ2 in FIG. 3A. That is, during the period from the position θ1 to the position θ2 in FIG. 3A, the duty cycle of the drive signal S1 increases when the amplitude value of the voltage command value Vu* increases on the positive side, and decreases when the amplitude value of the voltage command value Vu* increases on the negative side.

In contrast to the time from the position θ1 to the position θ2, the rotational speed ω\hat{ } or the modulation factor increases during the time from the position θ2 to the position θ5 in FIG. 3A, so that the duty cycle of the drive signal S1 may not correspond to the amplitude value of the voltage command value Vu*. That is, in the example shown in FIG. 3A, the pulse of the drive signal S1 is high during the time from the position θ3 to the position θ4 because the voltage command value Vu* is equal to or greater than the carrier wave at the position θ3, whereas it is preferable that the pulse of the drive signal S1 is low during the time from the position θ3 to the position θ4. Accordingly, if the rotational speed ω\hat{ } or the modulation factor becomes relatively large, the duty cycle of the drive signal S1 may not be varied according to the amplitude value of the voltage command value Vu*.

In the control device 1 of the first embodiment, the control period T2 during the time from the position θ2 to the position θ5 is shorter than the control period T1 during the time from the position θ1 to the position θ2 as shown in FIG. 3B. Accordingly, the number of samplings of the current Iu, the current Iv, and the current Iw during the time from the position θ2 to the position θ5 and the position θ\hat{ } or the position θ per unit time is larger than the number of samplings of the current Iu, the current Iv, and the current Iw during the time from the position θ1 to the position θ2, and the position θ\hat{ } or the position θ per unit time, so that the comparisons between the carrier wave and the voltage command value Vu* per unit time during the time from the position θ2 to the position θ5 becomes larger than the comparisons between the carrier wave and the voltage command value Vu* per unit time during the time from the position θ1 to the position θ2. This reduces the possibility that the duty cycle of the drive signal S1 may not be varied according to the amplitude value of the voltage command value Vu*. That is, in the example shown in FIG. 3B, the pulse of the drive signal S1 is low during part of the time from the position θ3 to the position θ4, whereas it is preferable that the pulse of the drive signal S1 is low during the time from the position θ3 to the position θ4.

Accordingly, since the control device 1 of the first embodiment is configured so that the control period is shortened as the rotational speed ω\hat{ } of the rotor of the electric motor M or the modulation factor increases, this configuration of the control device 1 reduces the possibility that the duty cycle of the drive signal S may not be varied according to the amplitude value of the voltage command value V* even if the rotational speed ω\hat{ } of the rotor of the electric motor M or the modulation factor becomes relatively large, thereby suppressing deterioration of controllability of the electric motor M.

Furthermore, since the control device 1 of the first embodiment is configured so that the control period when the rotational speed ω\hat{ } of the rotor of the electric motor M or the modulation factor is relatively small is larger than the control period when the rotational speed ω\hat{ } of the rotor of the electric motor M or the modulation factor is relatively large, this configuration of the control device 1 reduces the frequency of the process of the control circuit 3 per unit time, thereby reducing the load on the control circuit 3.

### Second Embodiment

In a control device of the second embodiment, the control period is shortened as the rotational speed ω\hat{ } of the rotor of the electric motor M or the modulation factor increases, of all processes of the control circuit 3, in a process for acquiring the current flowing through the electric motor M and in a process for estimating the position θ\hat{ } by using the acquired current, whereas the control period is constant in other processes. The configuration of the control device of the second embodiment is identical to that of the control device 1 shown in FIG. 1.

That is, in every first control period, the coordinate conversion unit 13 acquires the currents Iu, Iv, Iw flowing through the phases of the electric motor M and converts the currents Iu, Iv, Iw to the d-axis current Id and the q-axis current Iq by using the position θ\hat{ } output from the estimation unit 6.

The estimation unit 6 estimates the rotational speed ω\hat{ } and the position θ\hat{ } of the rotor in every first control period by using the d-axis voltage command value Vd* and the q-axis voltage command value Vq* output from the current control unit 11 and the d-axis current Id and the q-axis current Iq output from the coordinate conversion unit 13.

The subtraction unit 7 calculates the difference Δω between the rotational speed command value ω* externally input and the rotational speed ω\hat{ } output from the estimation unit 6 in every second control period.

The speed control unit 8 converts the difference Δω to the q-axis current command value Iq* in every second control period.

The subtraction unit 9 calculates the difference ΔId between the predetermined d-axis current command value Id* and the d-axis current Id output from the coordinate conversion unit 13 in every second control period.

The subtraction unit 10 calculates the difference ΔIq between the q-axis current command value Iq* output from the speed control unit 8 and the q-axis current Iq output from the coordinate conversion unit 13 in every second control period.

The current control unit 11 converts, in every second control period, the difference ΔId and the difference ΔIq to the d-axis voltage command value Vd* and the q-axis voltage command value Vq*.

For example, the coordinate conversion unit 12 converts the d-axis voltage command value Vd* and the q-axis voltage command value Vq* to the voltage command value Vu*, the voltage command value Vv*, and the voltage command value Vw* respectively corresponding to the phases of the electric motor M in every second control period by using the position θ\hat{ } output from the estimation unit 6.

The drive circuit 4 compares, in every second control period, the voltage command values Vu*, Vv*, Vw* output from the calculation unit 5 with a carrier wave and outputs the drive signals S1 to S6, which correspond to the comparison results, to the gate terminals of the switching elements SW1 to SW6.

The control circuit 3 shortens the first control period and keeps the second control period constant as the rotational speed ω\hat{ } or the modulation factor increases.

For example, it is assumed that the first control period and the second control period are set to the control period T1 when the rotational speed ω\hat{ } is equal to or below the threshold ωth, and it is also assumed that the first control period is set to the control period T2 while the second control period is maintained as the control period T1 when the rotational speed ω\hat{ } is above the threshold ωth. It is noted that the control period T2 is shorter than the control period T1.

In this case, the number of samplings of the currents Iu, Iv, Iw flowing through the electric motor M per unit time (e.g., one period of the currents Iu, Iv, Iw) when the rotational speed ω\hat{ } is above the threshold ωth is larger than the number of samplings of the currents Iu, Iv, Iw per unit time when the rotational speed ω\hat{ } is equal to or below the threshold ωth, so that the number of samplings of the d-axis current Id and the q-axis current Iq per unit time increases. This allows errors in the d-axis current and the q-axis current to be reduced by means, such as calculation of the moving average of the d-axis current Id and the q-axis current Iq by using the additional d-axis current Id and q-axis current Iq. This therefore allows an increase in the estimate accuracy of the position θ\hat{ } that is estimated by using the d-axis current Id and the q-axis current Iq as the errors in the d-axis current Id and the q-axis current Iq are reduced.

Accordingly, the control device of the second embodiment is configured so that the control period is shortened in the acquisition process for acquiring the current flowing through the electric motor M and in the estimate process for estimating the position θ\hat{ } by using the acquired current as the rotational speed ω\hat{ } or the modulation factor increases. This configuration allows an increase in the number of samplings of the current flowing through the electric motor M as the rotational speed ω\hat{ } or the modulation factor increases, thereby allowing an increase in the estimate accuracy of the position θ\hat{ }. This configuration therefore allows high-accuracy calculation of the voltage command values Vu*, Vv*, Vw* by using the position θ\hat{ }, thereby suppressing deterioration of controllability of the electric motor M. That is, the control device of the second embodiment allows an increase in the calculation accuracy of the voltage command value V* even if the rotational speed ω\hat{ } of the rotor of the electric motor M or the modulation factor becomes relatively large, thereby suppressing deterioration of controllability of the electric motor M.

The control device of the second embodiment allows the control period to be shortened in some of all processes of the control circuit 3, while keeping the control period constant in other processes, thereby suppressing the processing load on the control circuit 3.

Furthermore, the present invention is not limited to the foregoing embodiments, and various improvements and changes can be made without departing from the scope of the present invention.

### REFERENCE SIGNS LIST

1 control device

2 inverter circuit

3 control circuit

4 drive circuit

5, 5′ calculation unit

6, 6′ estimation unit

7 subtraction unit

8 speed control unit

9 subtraction unit

10 subtraction unit

11 current control unit

12, 12′ coordinate conversion unit

13, 13′ coordinate conversion unit

1. A control device for an electric motor comprising:
an inverter circuit configured to drive a rotor of the electric motor by a result of a comparison between a carrier wave and a voltage command value; and
a control circuit configured to determine the voltage command value in every control period by vector control by using a current flowing through the electric motor, and a rotational speed and a position of the rotor, wherein
the control circuit is configured to shorten the control period as the rotational speed of the rotor or a modulation factor corresponding to the rotational speed of the rotor increases.

2. The control device for the electric motor according to claim 1, wherein
the control circuit is configured to estimate the rotational speed and the position of the rotor in every control period by using the current flowing through the electric motor.

3. A control device for an electric motor comprising:
an inverter circuit configured to drive a rotor of the electric motor by a result of a comparison between a carrier wave and a voltage command value; and
a control circuit configured to determine the voltage command value by vector control by using a current flowing through the electric motor, and a rotational speed and a position of the rotor, wherein
the control circuit is configured to shorten the control period as the rotational speed of the rotor or a modulation factor corresponding to the rotational speed of the rotor increases, of all processes of the control circuit, in an acquisition process for acquiring the current flowing through the electric motor and in an estimate process for estimating the position by using the acquired current, whereas the control circuit is configured to keep the control period constant in the processes of the control circuit other than the acquisition process and the estimate process.
